(19) United States
(12) Patent Application Publication
(10) Pub. No.: US 2022/0212809 A1
(43) Pub. Date: Jul. 7, 2022

(54) AIR INTAKE LIP OF A TURBOMACHINE NACELLE COMPRISING AN ACOUSTIC DEVICE AND METHOD FOR PRODUCING SUCH A LIP

(71) Applicant: SAFRAN NACELLES, Gonfreville-L'Orcher (FR)

(72) Inventors: Virginie Emmanuelle Anne-Marie Digeos, Moissy-Cramayel (FR); Patrick Gonidec, Moissy-Cramayel (FR)

(21) Appl. No.: 17/614,148

(22) PCT Filed: May 14, 2020
(86) PCT No.: PCT/EP2020/063536

§ 371 Date: Nov. 24, 2021

(30) Foreign Application Priority Data
May 27, 2019 (FR) 1905563

(51) Int. Cl. B64D 33/02; F02C 7/045; F02C 7/047; B64D 29/00

(52) U.S. Cl. CPC B64D 33/02; F02C 7/045; F02C 7/047; F05D 2220/323; B64D 2033/0233; B64D 2033/0206; F05D 2250/283; B64D 29/00

(57) ABSTRACT

The invention relates to an air intake lip of an aircraft turbomachine nacelle extending along an axis X, in which an air flow circulates from upstream to downstream, the lip extending annularly about the X-axis and having an inner wall facing the X-axis and an outer wall which is opposite the inner wall, the inner wall and the outer wall being connected by an upstream wall so as to delimit an annular cavity, the lip comprising an annular acoustic device mounted in the annular cavity. The lip has a first module, comprising the outer wall, the wall and a front wall forming an upstream portion of the inner wall, and a second module, comprising the acoustic device and a front skin forming a downstream portion of the inner wall, the first module and the second module being secured together so that the front wall and the front skin together form the inner wall of the lip.

### TECHNICAL FIELD

The present invention relates to the field of aircraft turbomachines and is more particularly directed to an air intake lip of an aircraft turbomachine nacelle.

In a known manner, an aircraft comprises one or more turbomachines to allow its propulsion by acceleration of an air flow that circulates from upstream to downstream in the turbomachine.

With reference to FIG. 1, there is represented a turbomachine 100 extending along an axis X and comprising a fan 110 rotatably mounted about axis X in a nacelle comprising an internal shell 112 in order to accelerate an air flow F from upstream to downstream. Hereinafter, the terms upstream and downstream are defined with respect to the circulation of the air flow F. The turbomachine 100 comprises at its upstream end an air intake 102 that allows the incoming air flow F to be separated into an internal air flow FINT that is accelerated by the fan 110 and an external air flow FEXT that is guided externally to the nacelle.

With reference to FIG. 1, the air intake 102 comprises an upstream portion 102a, known to the person skilled in the art as a lip 102a, and a downstream portion 102b. In this example, the lip 102a is separated from the downstream portion 102b by an inner partition wall 125.

The lip 102a comprises an internal wall 121 pointing to axis X and an external wall 122 that is opposite to the internal wall 121, the walls 121, 122 are connected through an upstream wall 123 so as to form an annular cavity 120. Thus, the lip 102a enables the incoming air flow F to be separated into an internal air flow FINT guided by the internal wall 121 and an external air flow FEXT guided by the external wall 122. Hereinafter, the terms internal and external are defined radially with respect to axis X of the turbomachine 100.

The air circulation on the internal wall 121 of the lip 102a generates acoustic nuisance and it was proposed to equip the lip 102a with an annular acoustic device to limit this nuisance.

With reference to FIG. 2, a lip 102a equipped with an acoustic device 104 is known from patent application WO1216/005711. The acoustic device 104 comprises a rear skin 142 to which an acoustic, in particular, honeycomb material 140, is attached. In practice, the rear skin 142 is attached to the acoustic material 140 by soldering. The acoustic device 104 is positioned in the annular cavity 120 on the inner surface of the internal wall 121 of the lip 102a.

To integrate such an acoustic device 104, it is necessary to attach the rear skin 142 to the inner surface of the internal wall 121 and to form holes (not represented) in the internal wall 121 so as to allow circulation of the internal air flow FINT through the acoustic device 104 in order to limit acoustic nuisance.

In practice, attaching the rear skin 142 of the acoustic device 104 to the inner surface of the internal wall 121 of the lip 102a is performed by soldering using a 6061 type alloy that is compatible with the internal wall 121, which is generally made of aluminum to withstand de-icing temperatures.

Such a soldering step reduces mechanical characteristics of the internal wall 121. Also, it is necessary to increase its thickness to allow a good mechanical strength, thereby increasing the mass of the lip 102a. In fact, geometric tolerances in manufacturing the acoustic device 104 and the lip 102a make the assembly complex. Furthermore, during cooling following soldering, the internal wall 121 is susceptible to deformation. Furthermore, during soldering, the lip 102a should be placed in a soldering oven which is likely to cause the external wall 122 to collapse during heating. In addition, it is necessary to provide specific and complex tooling to hold the acoustic device 104 and the lip 102a together during soldering. Finally, machining of the acoustic holes in the internal wall 121 is complex because they should be precisely aligned with cells in the acoustic material 140 to ensure optimal acoustic treatment.

One of the objectives of the invention is to facilitate manufacture of an air intake lip comprising an annular acoustic device while having a reduced manufacturing cost.

Still with reference to FIG. 2, it is known to equip a lip 102a with a de-icing system in order to avoid accumulation of ice on the internal wall 121. For this purpose, it has been proposed to provide a hot air injector 103 in the annular cavity 120 and to form blow-out openings 130 in the internal wall 121, preferably, upstream of the acoustic device 104 in order to heat the internal wall 121. Machining such blow-out openings 130 is time consuming and complex to perform.

Another objective of the invention is to facilitate manufacture of an air intake lip comprising such blow-out openings.

Incidentally, an aircraft nacelle comprising an air intake, comprising an acoustic device, and a downstream body comprising another acoustic device is known in prior art from patent application FR2924409. Patent application FR2924409 does not set forth any solution for manufacturing an air intake but only deals with the assembly to a downstream body of a nacelle.

US2012048389A1 and US2012241249A1 teach an air intake comprising an acoustic attenuation member located downstream of the air intake lip, that is, outside the annular cavity. US2002139899A1 teaches an air intake lip without blow-out openings.

### SUMMARY

The invention relates to an air intake lip of an aircraft turbomachine nacelle extending along an axis X in which an air flow circulates from upstream to downstream, the lip annularly extending about axis X and comprising an internal wall pointing to axis X and an external wall which is opposite to the internal wall, the internal wall and the external wall being connected through an upstream wall, the lip comprising an annular acoustic device mounted in the annular cavity.

The invention is remarkable in that the lip comprises:
a first module, comprising the external wall, the upstream wall and a front wall forming an upstream portion of the internal wall and
a second module, comprising the acoustic device and a front skin forming a downstream portion of the internal wall, the first module and the second module being secured together so that the front wall and the front skin together form the internal wall of the lip.

According to the invention, the lip comprises two insert modules that are assembled together. Such a modular design makes it easier to hold and process the modules since their overall size is limited and can be achieved with simpler and less expensive equipment. Furthermore, the risk of defects is limited because it is easier to check the modules, which are accessible on both faces. A modular assembly allows the use of various assembly solutions without affecting health of the modules. In addition, mechanical characteristics of the internal wall are preserved and it is no longer susceptible to deformation. The external wall is also preserved. Finally, the second acoustic module can simply be replaced in case of a defect.

Preferably, the front skin comprises acoustic perforations. Advantageously, this allows the internal air flow to penetrate the acoustic device.

Preferably, the second module comprises a rear skin, with the acoustic device being housed between the front skin and the rear skin. The acoustic device is thus radially sandwiched.

Preferably, the front wall of the first module is radially internal to the front skin of the second module at an interface zone between the front wall and the front skin. This advantageously allows for a radial connection in the superimposition zone.

According to one aspect, the lip comprises at least one blow-out opening formed in the internal wall of the lip. Such a blow-out opening allows for de-icing of the internal wall of the lip.

Preferably, the blow-out opening is positioned upstream of the acoustic device to allow for de-icing of the front skin during circulation of the internal air flow.

Preferably, the lip comprises at least one blow-out opening formed at the interface between the front wall of the first module and the front skin of the second module. Such a blow-out opening advantageously avoids machining the front wall, thereby improving its mechanical strength. The blow-out opening is formed at the interface during assembly.

Even more preferably, the front wall of the first module is radially spaced from the front skin of the second module so as to form at least one blow-out opening between them. The blow-out opening advantageously comprises a guide channel for precisely guiding the hot de-icing air flow.

Preferably, the lip comprises a filling member housed between the front wall of the first module and the front skin of the second module, that is, in the guide channel of the blow-out opening.

Preferably, the front wall of the first module is radially spaced from the front skin of the second module by at least one spacer stud. Such a spacer stud is used to define the radial thickness of the blow-out opening. Preferably, the spacer stud has an aerodynamic shape so as to guide an air flow into the blow-out opening.

According to a preferred aspect, the spacer stud comprises an opening for guiding a mechanical connection member configured to secure the front wall of the first module to the front skin of the second module. Preferably, the spacer stud has an aerodynamic profile so as to guide the de-icing air flow in an optimal manner. It especially prevents the occurrence of turbulence due to the mechanical connection members.

According to one aspect, the lip comprises at least one inner partition wall mounted between the first module and the second module in the annular cavity, preferably between the inner surface of the external wall of the first module and the inner surface of the rear skin of the second module. Mounting such an inner partition wall is facilitated.

According to one aspect, the annular cavity comprises at least one injector of a hot air flow in order to allow de-icing by blowing through the blow-out opening.

The invention also relates to an aircraft air intake comprising a lip as previously set forth. Preferably, the air intake comprises an upstream portion, formed by the lip, and a downstream portion to which the lip is mounted.

The invention also relates to an aircraft turbomachine comprising a nacelle comprising an air intake as previously set forth.

The invention also relates to a method for manufacturing an air intake lip, as previously set forth, comprising a step of manufacturing the first module and the second module independently and a step of securing the first module to the second module so that the front wall and the front skin together form the internal wall of the lip.

### BRIEF DESCRIPTION OF THE DRAWINGS

The invention will be better understood upon reading the following description, which is given solely by way of example, and refers to the appended drawings given as non-limiting examples, in which identical references are given to similar objects and in which:

FIG. 1 is a schematic representation in a longitudinal cross-section view of a turbomachine comprising a nacelle with an air intake;

FIG. 2 is a schematic representation in a longitudinal cross-section view of an air intake comprising an acoustic device according to prior art;

FIG. 3 is a schematic representation in a longitudinal cross-section view of a step of manufacturing an air intake according to prior art;

FIG. 4 is a schematic representation in a longitudinal cross-section view of a lip comprising a first main module and a second acoustic module assembled together;

FIG. 5 is a schematic representation of the second acoustic module for a lip according to the invention;

FIG. 6 is a schematic perspective representation of a lip according to the invention with an inner partition wall;

FIGS. 7A and 7B are schematic representations in a longitudinal cross-section view and a partial perspective view of a first embodiment of an assembly of a lip comprising blow-out openings;

FIGS. 8A and 8B are schematic longitudinal section and partial perspective representations of a second embodiment of an assembly of a lip comprising blow-out openings;

FIG. 8C is a schematic representation in a longitudinal cross-section view of a downstream end of the first main module according to one aspect of the invention;

FIG. 9 is a schematic representation in a longitudinal cross-section view of a third embodiment of an assembly of a lip comprising blow-out openings;

FIG. 10 is a schematic perspective representation of an assembly of a lip comprising blow-out openings and a filling member;

FIGS. 11A and 11B are partial schematic perspective representations of an assembly of a lip comprising blow-out openings and contoured spacer studs.

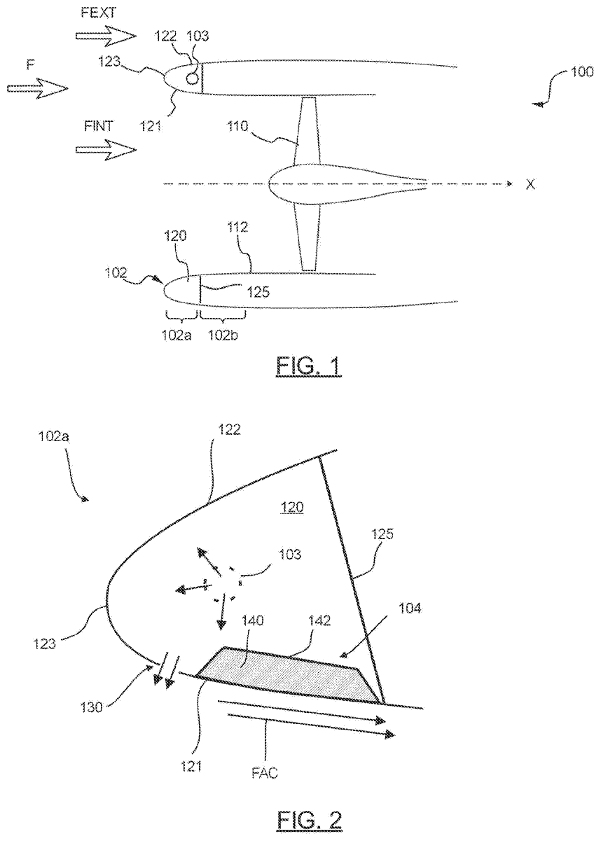

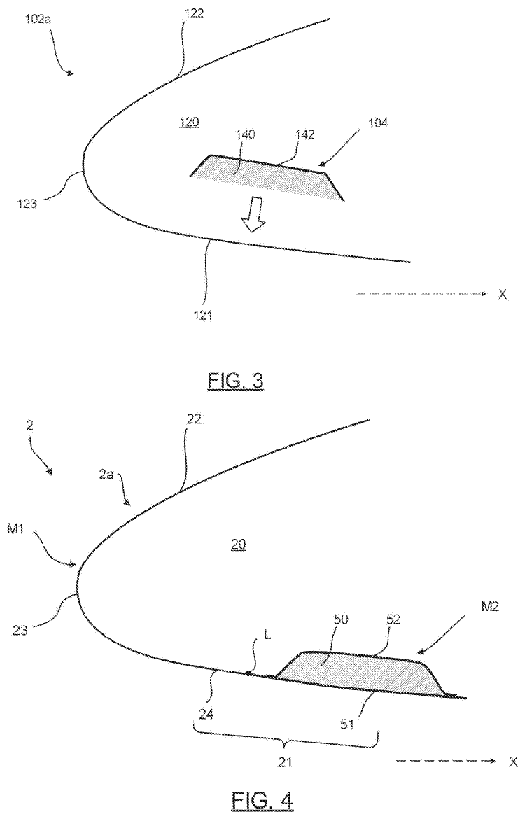

It should be noted that the figures set out the invention in detail for implementing the invention, said figures of course being able to serve to better define the invention where appropriate.

### DETAILED DESCRIPTION

With reference to FIG. 4, an air intake 2 of an aircraft turbomachine nacelle according to an embodiment of the invention, in particular, a turbojet engine nacelle is represented. The turbomachine extends along an axis X and allows circulation, during a thrust, of an air flow from upstream to downstream. Hereafter, axis X is oriented from upstream to downstream. With reference to FIG. 6, the air intake 2 comprises an upstream portion 2a, known to the person skilled in the art as lip 2a, and a downstream portion 2b. In this example, the lip 2a is separated from the downstream portion 2b by an inner partition wall 25.

The lip 2a annularly extends about axis X and comprises an internal wall 21 pointing to axis X and an external wall 22 that is opposite to the internal wall 21. The walls 21, 22 are connected through an upstream wall 23 so as to delimit an annular cavity 20. Thus, the lip 2a enables the incoming air flow to be separated into an internal air flow guided by the internal wall 21 and an external air flow guided by the external wall 22. Hereafter, the terms internal and external are defined radially with respect to axis X of the turbomachine. The lip 2a comprises an annular acoustic device 50 mounted in the annular cavity 20.

According to the invention, the lip 2a comprises a first module M1, comprising the external wall 22, the upstream wall 23 and a front wall 24 that forms an upstream portion of the internal wall 21. The lip 2a further comprises a second module M2, comprising the acoustic device 50 and a front skin 51 that forms a downstream portion of the internal wall 21, the first module M1 and the second module M2 being secured together so that the front wall 24 and the front skin 51 together form the internal wall 21 of the lip 2a. Preferably, the internal wall 21 has an aerodynamic shape to optimally guide the air flow in the secondary stream of the turbomachine.

In other words, contrary to prior art which taught to make a one-piece internal wall 21, a modular internal wall 21 which comprises a front wall 24, forming an upstream portion, and a front skin 51, forming a downstream portion, which are secured during assembly, is set forth. As will be set forth later, such a modular design allows a second acoustic module M2 to be formed independently, thereby facilitating the manufacture thereof and limiting the risk of defects during assembly.

As illustrated in FIG. 4, the first module M1, also referred to as the main module M1, has a structure similar to prior art except that it does not have a long internal wall but only a shortened internal wall called a front wall 24. Preferably, the main module M1 is made of a metallic material, preferably, resistant to high temperatures, for example, of aluminum. Several embodiments of a main module M1 will be set forth below. The first module M1 is preferably as one-piece.

In this embodiment, the first module M1 is made by forming (explosively or otherwise) or by flow forming.

As illustrated in FIG. 4, the second module M2, also referred to as the acoustic module M2, has an acoustic device 50 which is, in this example, in the form of a honeycomb structure. The acoustic device 50 comprises a plurality of acoustic, preferably metallic, cells. Nevertheless, it goes without saying that the acoustic device 50 could be in other forms.

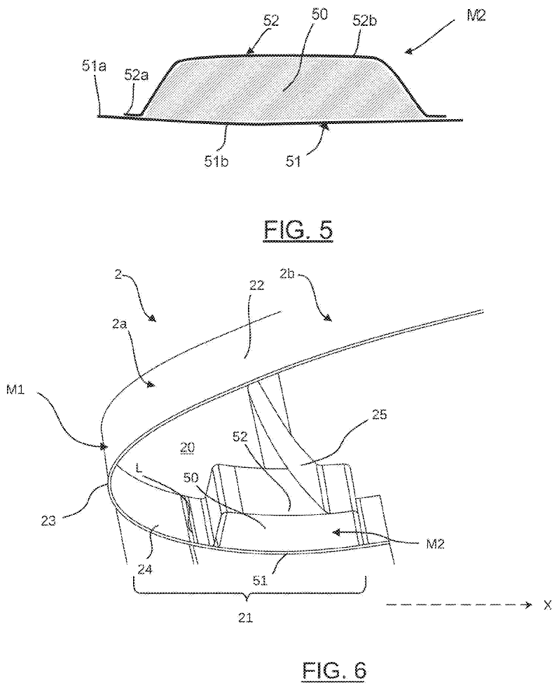

With reference to FIGS. 4 and 5, the second module M2 comprises a front skin 51 and a rear skin 52 between which the acoustic device 50 is mounted. The front skin 51 of the second acoustic module M2 is configured to extend as an extension of the front wall 24 of the first module M1. The front skin 51 is preferably made of a metallic material, especially, of aluminum.

The front skin 51 comprises a plurality of perforations so as to put the acoustic device 50 in communication with the air flow circulating inside the lip 2a. The perforations may be made before or after assembly of the second module M2. Similarly, the perforations may be made before or after assembly of modules M1, M2.

The rear skin 52 defines a concavity in which the acoustic device 50 is housed. The rear skin 52 is preferably made of a metallic material, especially of aluminum. The acoustic device 50 is secured, preferably by soldering, to the rear skin 52.

As illustrated in FIG. 5, in a longitudinal cross-section view, the rear skin 52 comprises a concave central portion 52b and two end portions 52a that are secured to the front skin 51. Such securing is simple to implement since it is carried out independently of the first module M1. Preferably, the rear skin 52 is secured to the front skin 51 by soldering, welding or the like or by mechanical assembly. Advantageously, the second module M2 has a reduced overall size thereby facilitating its soldering and assembly in an oven. Moreover, upon manufacturing the second module M2, mechanical properties of the first module M1 are advantageously not affected.

Preferably, the ends 51a of the front skin 51 are longer than those of the rear skin 52 so as to be secured to the first module M1 as will be set forth hereafter.

After assembly, the second module M2 can be stored, handled and used independently of the first module M1, which significantly simplifies logistics and assembly of the lip 2a.

Advantageously, the first module M1 and the second module M2 can be obtained by different methods.

Advantageously, the modules M1, M2 are manufactured independently and then assembled together. The assembly is preferably performed mechanically, by welding (laser, friction, electron beam, etc.) or the like.

With reference to FIG. 6, according to one aspect of the invention, the air intake 2 comprises an inner partition wall 25 so as to form a closed annular cavity 20 in which a de-icing air flow can especially circulate. In this example, the inner partition wall 25 is mounted between the external wall 22 of the first module M1 and the rear skin 52 of the second module M2. Such a design is advantageous since it allows, on the one hand, to maximize the dimensions of the acoustic device 50 and, on the other hand, to facilitate mounting of the inner partition wall 25 which can be previously mounted to the first module M1 or to the second module M2. Nevertheless, it goes without saying that the acoustic device 50 could be independent of the inner partition wall 25 and spaced from the latter, in particular, the inner partition wall 25 could be located downstream of the acoustic device 50.

In this example, the assembly of an inner partition wall 25 in the air intake 2 has been set forth. Such an inner partition wall 25 is not required and may be omitted depending on the configurations of the air intake 2. Hereinafter, for the sake of clarity and brevity, such an inner partition wall 25 is not represented, but of course could be provided.

As previously indicated, the air intake 2 comprises an upstream portion 2a and a downstream portion 2b. Following its manufacture, the lip 2a may be mounted to a downstream portion 2b to form the air intake 2. Preferably, the downstream portion 2b comprises an acoustic device. According to one aspect of the invention, the acoustic device of the downstream part 2b is independent of the acoustic device 50 of the lip 2a. According to another aspect of the invention, the acoustic device continuously extends between the downstream portion 2b and the lip 2a to provide optimal acoustic attenuation. An inner partition wall 25 between the lip 2a and the downstream portion 2b of the air intake 2 has been set forth but is optional.

According to one aspect of the invention, the annular cavity 20 comprises at least one injector of a hot air flow, in particular, for de-icing the lip 2a. According to one aspect of the invention, the lip 2a comprises at least one blow-out opening in the internal wall 21, preferably a plurality of blow-out openings in order to guide the hot air flow out of the annular cavity 20 and thereby de-ice the internal wall 21.

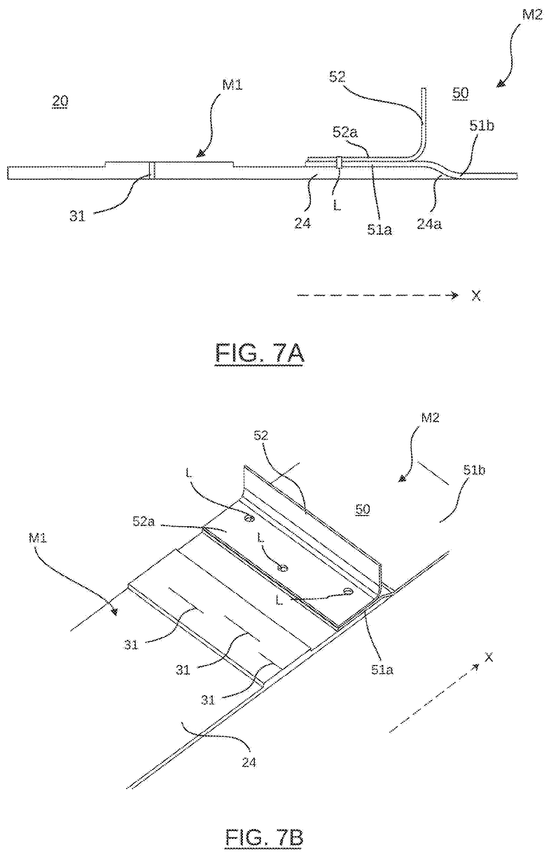

Several embodiments of blow-out openings will now be set forth with reference to FIGS. 7A through 11B.

As illustrated in FIGS. 7A and 7B, according to a first embodiment, the first module M1 and the second module M2 are secured together at an interface zone in which one end 51a of the front skin 51 of the second module M2 is secured to the front wall 24 of the first module M1. Preferably, in the interface zone, the front skin 51 is radially internal to the front wall 24 of the first module M1 so as to allow securing in a radial direction, for example, by welding or mechanical connection. In this embodiment, three connections L are represented in FIG. 7B.

In order to form a lip 2a having an internal wall 21 having an aerodynamic curvature, the front skin 51 of the second module M2 is curved so as to comprise an end portion 51a superimposed to the front wall 24 of the first module M1 to allow attachment and a central portion 51b as an extension of the front wall 24 of the first module M1 as illustrated in FIG. 7A.

Preferably, as illustrated in FIG. 7A, the downstream end 24a of the front wall 24 is beveled so as to snugly fit the curvature of the front skin 51 of the second module M2, with its radially external surface converging radially inwardly along an upstream-downstream direction. Such a bevel is simple to make and avoids a significant deformation of the front skin 51 in order to keep an aerodynamic profile. The bevel thus faces a curvature of the front skin 51 to obtain a continuous internal wall 21.

As illustrated in FIGS. 7A and 7B, the front wall 24 of the first module M1 comprises a plurality of blow-out openings 31 that are formed away from the downstream end of the front wall 24. In this example, the blow-out openings 31 extend substantially radially into the material of the front wall 24. Such an independent blow-out opening 31 is known to the skilled person as “separated slot”. With reference to FIG. 7B, each blow-out opening 31 is in this example in the form of an azimuthally directed slot. Of course, the shape and direction could be different.

The blow-out openings 31 are formed in the first module M1 independently of the second module M2. With reference to FIG. 7A, the blow-out openings 31 are formed in an extra thickness of the front wall 24, such an extra thickness is nevertheless not necessary.

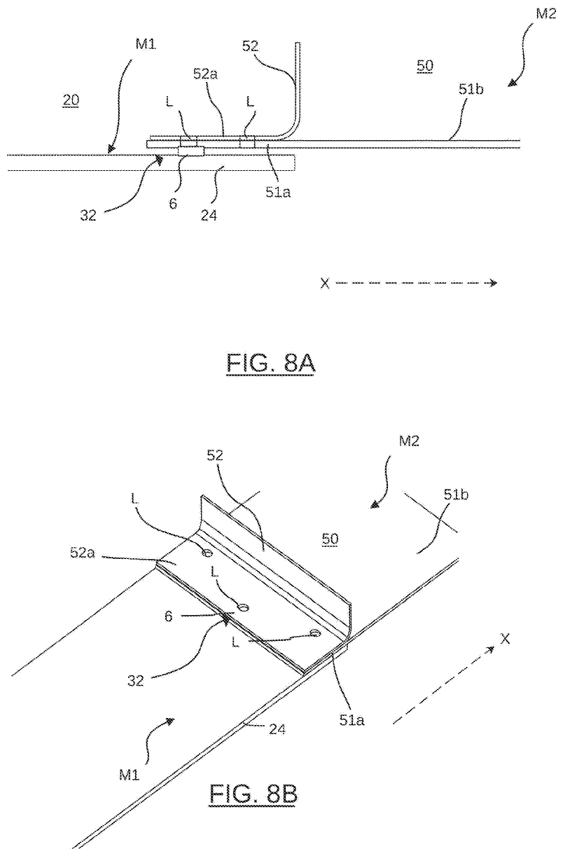

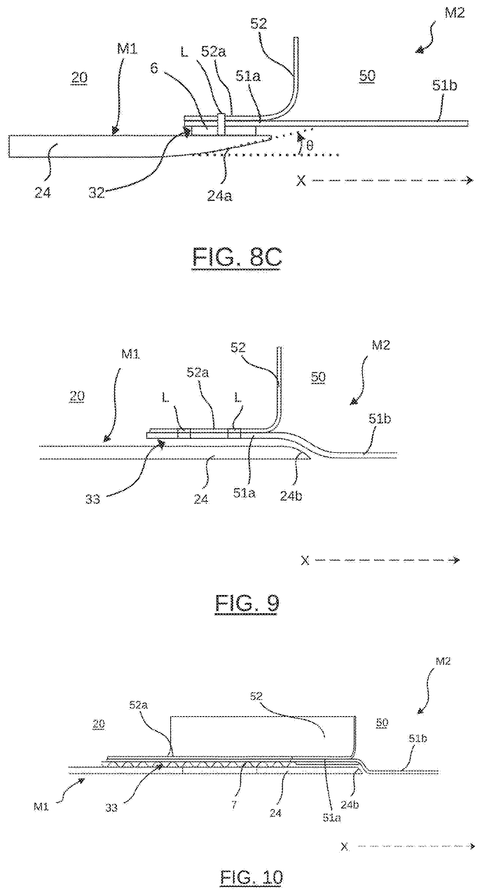

According to a second embodiment, as illustrated in FIGS. 8A and 8B, the first module M1 and the second module M2 are secured together at an interface zone in which the end 51a of the front skin 51 of the second module M2 is secured to the front wall 24 of the first module M1. Preferably, in the interface zone, the front skin 51 is radially internal to the front wall 24 of the first module M1 so as to allow securing along a radial direction.

In this second embodiment, the front wall 24 and the front skin 51 are spaced apart radially by a plurality of spacer studs 6, or wedges, mounted between the front wall 24 and the front skin 51. Preferably, at least one spacer stud 6 comprises a radial passage opening for guiding a mechanical connection member L, for example, a rivet. Thus, when assembling the first module M1 with the second module M2, the front wall 24 and the front skin 51 are spaced apart so as to form between them an air blow-out opening 32 comprising a guide channel, preferably of annular shape. Preferably, a spacer stud 6 has a radial thickness between 1 mm and 8 mm to form a guide channel of calibrated thickness. Preferably, the radial thickness depends on the desired de-icing conditions (temperature, pressure, etc.)

Advantageously, unlike the first embodiment, there is no need to drill through the front wall 24 of the first module M1, the blow-out opening 32 is here formed at the interface zone during assembly. Mechanical stresses in the front wall 24 of the first module M1 are thereby limited. Such an offset blow-out opening 32 is known to the skilled person as “step down slot”. In this example, the blow-out opening 32 is circumferential.

With reference to FIG. 8A, the internal wall 21 of the lip 2a comprises a radial discontinuity due to the gap between the front wall 24 and the front skin 51. Alternatively, with reference to FIG. 8C, the downstream end 24a of the front wall 24 is beveled, its radially inner surface converging radially outward along an upstream to downstream direction. Such a bevel is simple to make and significantly limits aerodynamic discontinuities at the interface between the front wall 24 and the front skin 51. Good performance is achieved for a bevel angle θ less than 15° as illustrated in FIG. 8C. Preferably, the radially internal surface is curved to form an aerodynamic profile.

According to a third embodiment, as illustrated in FIG. 9, the front skin 51 of the second module M2 is curved so as to comprise an end portion 51a facing the front wall 24 of the first module M1 to allow radial attachment and a central portion 51b as an extension of the front wall 24 of the first module M1.

In this embodiment, the front wall 24 and the front skin 51 have substantially the same shape as in the first embodiment but are radially spaced apart in a manner analogous to the second embodiment, in particular, by spacer studs 6 (not represented in FIG. 9) and is in the form of an annular slot.

Advantageously, a blow-out opening 33 is formed here at the interface zone during assembly. The blow-out opening 33 comprises a guide channel extending longitudinally between the front wall 24 and the front skin 51 so as to guide the hot air flow. The blow-out opening 33 opens at the interface between the front wall 24 and the front skin 51 which are aligned. Such a buried blow-out opening 33 is known to the skilled person as “buried slot”. In this example, the blow-out opening 33 is circumferential.

According to one alternative of the invention, with reference to FIG. 10, when the blow-out opening 32, 33 comprises a guide channel formed between the front wall 24 and the front skin 51, a filling member 7 can advantageously be provided in the guide channel so as to act on the hot air flow before it is discharged.

Preferably, the filling member 7 can comprise elementary channels in order to separate the hot air flow into a plurality of elementary flows so as to promote guidance and allow optimal de-icing. As an example, the filling member 7 comprises a corrugated panel sandwiched between two circumferential panels. Further preferably, the filling member 7 is made of a metallic material.

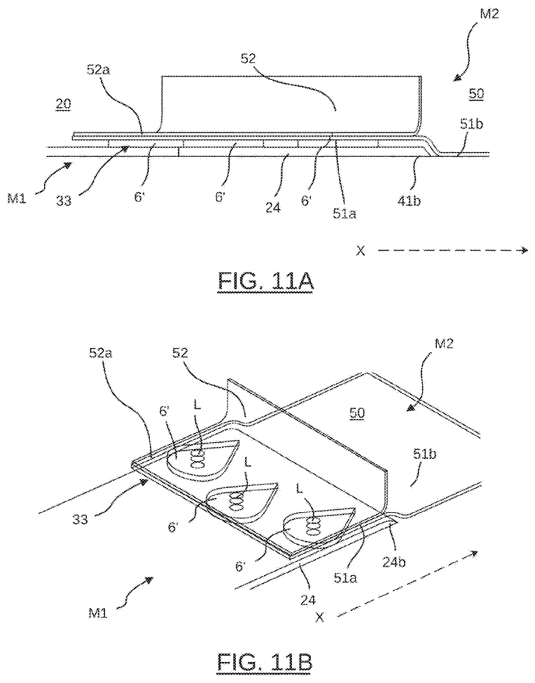

According to an alternative of the invention, with reference to FIGS. 11A and 11B, the lip 2a comprises spacer studs 6′ having an aerodynamic profile so as to define an upstream-oriented leading edge and a downstream-oriented trailing edge. Preferably, a spacer stud 6′ is shaped like a drop of water as illustrated in FIGS. 11A and 11B, the cross-section of which increases and then decreases from upstream to downstream. However, it goes without saying that each spacer stud could have a different shape

The spacer studs 6, 6′ (with an aerodynamic or non-aerodynamic profile) can be mounted as an insert between the front wall 24 and the front skin 51, but can also be made of the material of the front wall 24 or of the front skin 51. Preferably, the spacer studs 6, 6′ are made of the material of the front wall 24 and formed upon making the first module M1.

By virtue of the invention, a modular design makes it easier to hold and treat the modules M1, M2, since their overall size is limited and can be achieved with simpler and less expensive equipment. Furthermore, the risk of defects is limited because the modules M1, M2 are accessible on each of their faces, which facilitates their inspection. Moreover, a modular assembly allows for various assembly solutions without affecting health of the modules M1, M2.

In particular, by virtue of the invention, mechanical characteristics of the internal wall 21 are preserved and it is no longer susceptible to deformation. The external wall 22 is also preserved since it is no longer introduced into a soldering furnace. Finally, the second acoustic module M2 can simply be replaced in case of defect.

1-6. (canceled)

7. A lip of an air intake of an aircraft turbomachine nacelle extending along an axis X in which an air flow circulates from upstream to downstream, the lip annularly extending about axis X and comprising an internal wall pointing to axis X and an external wall which is opposite to the internal wall, the internal wall and the external wall being connected through an upstream wall so as to delimit an annular cavity, the lip comprising an annular acoustic device mounted in the annular cavity, the lip comprising:
a first module, comprising the external wall, the upstream wall and a front wall forming an upstream portion of the internal wall; and
a second module, comprising the acoustic device and a front skin forming a downstream portion of the internal wall, the first module and the second module being secured together so that the front wall and the front skin together form the internal wall of the lip, the front wall of the first module being spaced radially from the front skin of the second module by at least one spacer stud so as to form between them at least one blow-out opening.

8. The lip of an air intake according to claim 7, wherein the second module comprising a rear skin, the acoustic device is housed between the front skin and the rear skin.

9. The lip of an air intake according to claim 8, wherein the front wall of the first module is radially internal to the front skin of the second module at an interface zone between the front wall and the front skin.

10. The lip of an air intake according to claim 7, wherein the spacer stud has an aerodynamic shape so as to guide an air flow into the blow-out opening.

11. The lip of an air intake according to claim 7, wherein the spacer stud comprises an opening for guiding a mechanical connection member configured to secure the front wall of the first module to the front skin of the second module.

12. A method for manufacturing the lip of an air intake according to claim 7, comprising a step of independently manufacturing the first module and the second module, and a step of securing the first module to the second module so that the front wall and the front skin together form the internal wall of the lip.
